(19) United States
(12) Patent Application Publication
(10) Pub. No.: US 2006/0008147 A1
(43) Pub. Date: Jan. 12, 2006

(54) Apparatus, medium, and method for extracting character(s) from an image

(75) Inventors: Cheolkon Jung, Suwon-si (KR); Jiyeun Kim, Suwon-si (KR); Youngsu Moon, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/133,394

(22) Filed: May 20, 2005

(30) Foreign Application Priority Data
May 21, 2004 (KR) 10-2004-0036393

(51) Int. Cl. G06K 9/34; G06K 9/00

(52) U.S. Cl. 382/176; 382/171

(57) ABSTRACT

An apparatus, medium, and method for extracting character(s) from an image. The apparatus includes a mask detector detecting a height of a mask indicating a character(s) region from spatial information of the image created when detecting a caption region including the character(s) region and a background region from the image and a character(s) extractor extracting character(s) from the character(s) region corresponding to the height of the mask. The spatial information includes an edge gradient of the image. Therefore, the apparatus extracts important information from an image and can recognize small character(s) that are not recognizable using conventional methods. In addition, an image can be more accurately identified, summarized, searched, and indexed according to its contents by recognizing extracted character(s). Further, the apparatus enables faster character(s) extraction.

### CROSS-REFERENCE TO RELATED APPLICATIONS

This application claims the benefit of Korean Patent Application No. 2004-36393, filed on May 21, 2004, in the Korean Intellectual Property Office, the disclosure of which is incorporated herein in its entirety by reference.

### BACKGROUND OF THE INVENTION

1. Field of the Invention

Embodiments of the present invention relate to image processing, and more particularly to apparatuses, media, and methods for extracting character(s) from an image.

2. Description of the Related Art

Conventional methods of extracting character(s) from an image include thresholding, region-merging, and clustering.

Thresholding undermines the performance of character(s) extraction since it is difficult to apply a given threshold value to all images. Variations of thresholding are discussed in U.S. Pat. Nos. 6,101,274 and 6,470,094, Korean Patent Publication No. 1999-47501, and a paper entitled “A Spatial-temporal Approach for Video Caption Detection and Recognition,” IEEE Trans. on Neural Network, vol. 13, no. 4, July 2002, by Tang, Xinbo Gao, Jianzhuang Liu, and Hongjiang Zhang.

Region-merging requires a lot of calculating time to merge regions with similar averages after segmenting an image, thereby providing low-speed character(s) extraction. Region-merging is discussed in a paper entitled “Character Segmentation of Color Images from Digital Camera,” Document Analysis and Recognition, 2001, Proceedings, and Sixth International Conference on, pp. 10-13, September 2001, by Kongqiao Wang, Kangas, J. A., and Wenwen Li.

Variations of clustering are discussed in papers entitled “A New Robust Algorithm for Video Character Extraction,” Pattern Recognition, vol. 36, 2003, by K. Wong and Minya Chen, and “Study on News Video Caption Extraction and Recognition Techniques,” the Institute of Electronics Engineers of Korea, vol. 40, part SP, no. 1, January 2003, by Jong-ryul Kim, Sung-sup Kim, and Young-sik Moon.

These conventional techniques have drawbacks. For example, small character(s) cannot be recognized because OCR (Optical Character Recognition) cannot recognize character(s) with a height of equal to or less than 20-30 pixels.

### SUMMARY OF THE INVENTION

Embodiments of the present invention set forth apparatuses, methods, and media for extracting character(s) from an image, extracting and recognizing small character(s).

According to an aspect of the present invention, there is provided an apparatus for extracting character(s) from an image. The apparatus includes a mask detector detecting a height of a mask indicating a character(s) region from spatial information of the image created when detecting a caption region comprising the character(s) region and a background region from the image; and a character(s) extractor extracting character(s) from the character(s) region corresponding to the height of the mask. The spatial information may include an edge gradient of the image.

According to another aspect of the present invention, there is provided a method of extracting character(s) from an image. The method includes obtaining a height of a mask indicating a character(s) region from spatial information of the image created when detecting a caption region comprising the character(s) region and a background region from the image; and extracting the character(s) from the character(s) region corresponding to the height of the mask. The spatial information may include an edge gradient of the image.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus for extracting character(s) from an image, according to an embodiment of the present invention;

FIG. 2 is a flowchart illustrating a method of extracting character(s) from an image, according to an embodiment of the present invention;

FIG. 3 is a block diagram of a mask detector illustrated in FIG. 1, according to an embodiment of the present invention;

FIGS. 4A though 4C are views explaining a process of generating an initial mask, according to embodiments of the present invention;

FIGS. 5A and 5B are views explaining an operation of a line detector illustrated in FIG. 3, according to an embodiment of the present invention;

FIG. 6 is an exemplary graph explaining a time average calculator illustrated in FIG. 1, according to an embodiment of the present invention;

FIG. 7 is a block diagram of a character(s) extractor, according to an embodiment of the present invention;

FIG. 8 is a flowchart illustrating operation 46 in FIG. 2, according to an embodiment of the present invention;

FIG. 9 is a block diagram of a character(s) extractor, according to another embodiment of the present invention;

FIG. 10 is a graph illustrating a cubic function;

FIG. 11 is a one-dimensional graph illustrating an interpolation pixel and neighboring pixels;

FIG. 12 illustrates a sharpness unit, according to an embodiment of the present invention;

FIG. 13 is a block diagram of a second binarizer of FIG. 7 or FIG. 9, according to an embodiment of the present invention;

FIG. 14 is a flowchart illustrating a method of operating the second binarizer of FIG. 7 or 9, according to an embodiment of the present invention;

FIG. 15 is an exemplary histogram, according to an embodiment of the present invention;

FIG. 16 is a block diagram of a third binarizer, according to an embodiment of the present invention;

FIG. 17 is a flowchart illustrating operation 164 of FIG. 14, according to an embodiment of the present invention;

FIG. 18 is a block diagram of a noise remover, according to an embodiment of the present invention; and

FIGS. 19A through 19D illustrate an input and an output of a character(s) extractor and a noise remover illustrated in FIG. 7, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

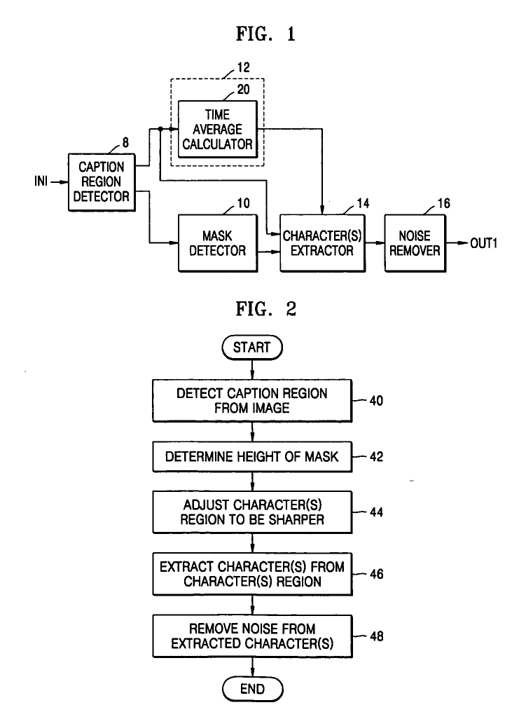

FIG. 1 is a block diagram of an apparatus for extracting character(s) from an image, according to an embodiment of the present invention. Referring to FIG. 1, the apparatus includes a caption region detector 8, a mask detector 10, a first sharpness adjuster 12, a character(s) extractor 14, and a noise remover 16.

FIG. 2 is a flowchart illustrating a method of extracting character(s) from an image according to an embodiment of the present invention. The method includes operations of extracting character(s) from a character(s) region using a height of a mask (operations 40 through 46) and removing noise from the extracted character(s) (operation 48).

The caption region detector 8 detects a caption region of an image input via an input terminal IN1 and outputs spatial information of the image created when detecting the caption region to the mask detector 10 (operation 40). Here, the caption region includes a character(s) region having only character(s) and a background region that is in the background of a character(s) region. Spatial information of an image denotes an edge gradient of the image. Character(s) in the character(s) region may be character(s) contained in an original image or superimposed character(s) intentionally inserted into the original image by a producer. A conventional method of detecting a caption region from a moving image is disclosed in Korean Patent Application No. 2004-10660.

After operation 40, the mask detector 10 determines the height of the mask indicating the character(s) region from the spatial information of the image received from the caption region detector 8 (operation 42).

The apparatus of FIG. 1 need not include the caption region detector 8 and may include only the mask detector 10, the first sharpness adjuster 12, the character(s) extractor 14, and the noise remover 16.

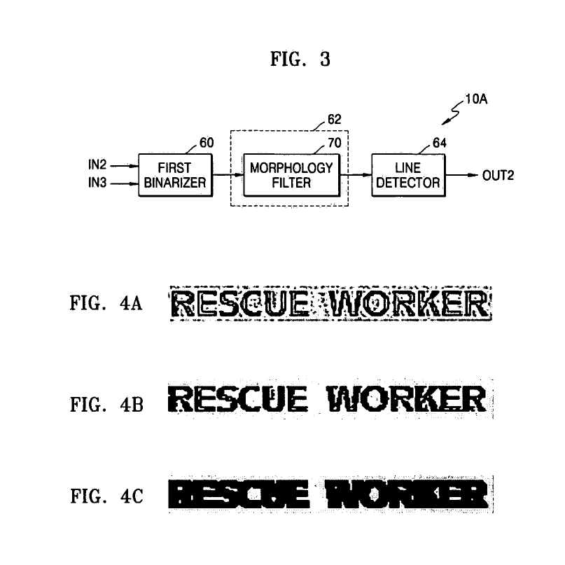

FIG. 3 is a block diagram of a mask detector 10A, according to an embodiment of the present invention. The mask detector 10A includes a first binarizer 60, a mask generator 62, and a line detector 64.

FIGS. 4A through 4C are views explaining a process of generating an initial mask. FIGS. 4A through 4C include a character(s) region, “rescue worker,” and a background region thereof. For a better understanding of the mask detector 10A of FIG. 3, it is assumed that the character(s) included in the character(s) region are “rescue worker.” The configuration and an operation of the mask detector 10A of FIG. 3 will now be described with reference to FIGS. 4A through 4C. However, the present invention is not limited to this configuration.

The first binarizer 60 binarizes spatial information, illustrated in FIG. 4A, received from the caption region detector 8 via an input terminal IN2 by using a first threshold value TH₁ input via input terminal IN3 and outputs the binarized spatial information illustrated in FIG. 4B to the mask generator 62.

The mask generator 62 removes holes in the character(s) of the image from the binarized spatial information of FIG. 4B received from the first binarizer 60 and outputs the result illustrated in FIG. 4C to the line detector 64 as an initial mask. Here, the holes in the character(s) denote white spaces within the black character(s) “rescue worker” illustrated in FIG. 4B. The initial mask indicates the black character(s) “rescue worker” not including the white background region, as illustrated in FIG. 4C.

According to an embodiment of the present invention, the mask generator 62 may be a morphology filter 70, morphology-filtering the binarized spatial information received from the first binarizer 60 and outputting the result of the morphology-filtering as an initial mask. The morphology filter 70 may generate an initial mask by performing a dilation method on the binarized spatial information output from the first binarizer 60. The morphology filtering and dilation methods are discussed in “Machine Vision,” McGraw-Hill, pp. 61-69, 1995, by R. Jain, R. Kastuni, and B. G. Schunck.

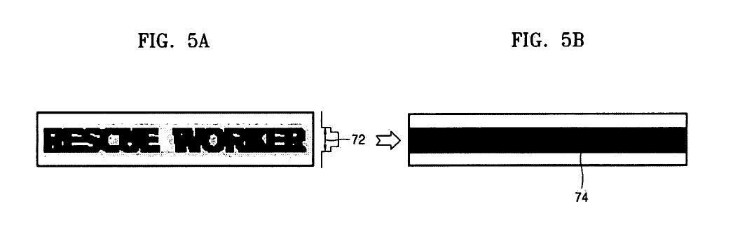

FIGS. 5A and 5B are views explaining the operation of the line detector 64 illustrated in FIG. 3. FIG. 5A illustrates the initial mask shown in FIG. 4C, and FIG. 5B illustrates a character(s) line.

The line detector 64 detects a height 72 of the initial mask illustrated in FIG. 5A, received from the mask generator 62, and outputs the result of the detection via an output terminal OUT2. The line detector 64 detects a character(s) line 74 illustrated in FIG. 5B indicating a width that is the height 72 of the initial mask, and outputs the detected character(s) line 74 via the output terminal OUT2. The character(s) line 74 includes at least the text region of the caption region since the character(s) line 74 has the width that is the height 72 of the initial mask and character(s) are not displayed in the character(s) line 74.

After Operation 42, the first sharpness adjuster 12 adjusts the sharpness of the character(s) region of the caption region received from the caption region detector 8 and outputs the character(s) region with adjusted sharpness to the character(s) extractor 14 (operation 44 of FIG. 2). To this end, the caption region detector 8 detects the caption region of the image input via the input terminal IN1 and outputs the detected caption region to the first sharpness adjuster 12 as time information of the image.

After operation 44 of FIG. 2, the character(s) extractor 14 extracts character(s) from the character(s) region with the adjusted sharpness received from the first sharpness adjuster 12 (operation 46).

According to an embodiment of the present invention, unlike the illustration of FIG. 2, operation 44 may be performed before operation 42. In this case, operation 46 can be performed after operation 42. In addition, operations 42 and 44 may also be performed simultaneously after operation 40.

According to an embodiment of the present invention, the first sharpness adjuster 12 illustrated in FIG. 1 may be a time average calculator 20. The time average calculator 20 receives caption regions with the same character(s) from the caption region detector 8 and calculates an average of luminance levels of the caption regions over time by

$$\overline{R} = \frac{1}{{N}_{f}} \sum {R}_{t} , \qquad ( 1 )$$

where \overline{R} denotes an average of luminance levels over time, N_{f} denotes the number of caption frames having the same character(s), and Rₜ denotes the luminance level of a caption region in a t^{th} frame.

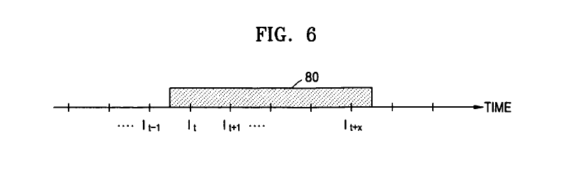

FIG. 6 is an exemplary graph for a better understanding of the average time calculator 20 illustrated in FIG. 1. Referring to FIG. 6, a plurality of I-frames ( . . . Iₜ₋₁, Iₜ, Iₜ₊₁, . . . Iₜ₊ₓ . . . ) are considered. Here, Iₜ₊ₓ denotes a t+X^{th} I-frame, and X is an integer.

For example, if all of the t^{th} through t+X^{th} I-frames, Iₜ through Iₜ₊ₓ, 80 include caption regions having the same character(s), N_{f} in Equation 1 is X+1.

When the luminance levels of the caption regions having the same character(s) are averaged over time, the character(s) becomes clearer because areas other than the character(s) in the caption regions include random noise.

When the first sharpness adjuster 12 is implemented as the time average calculator 20, the character(s) extractor 14 extracts character(s) from the character(s) region having, as a luminance level, an average calculated by the time average calculator 20.

Unlike the apparatus of FIG. 1, an apparatus for extracting character(s) from an image according to another embodiment of the present invention may not include the first sharpness adjuster 12. In other words, operation 44 of FIG. 2 may be omitted. In this case, after operation 42, the character(s) extractor 14 extracts character(s) from a character(s) region corresponding to a height of a mask received from the caption region detector 8 (operation 46). Thus, except that the character(s) region is input by the caption region detector 8 instead of the first sharpness adjuster 12, the operation of the character(s) extractor 14 when the first sharpness adjuster 12 is not included is the same as when the first sharpness adjuster 12 is included.

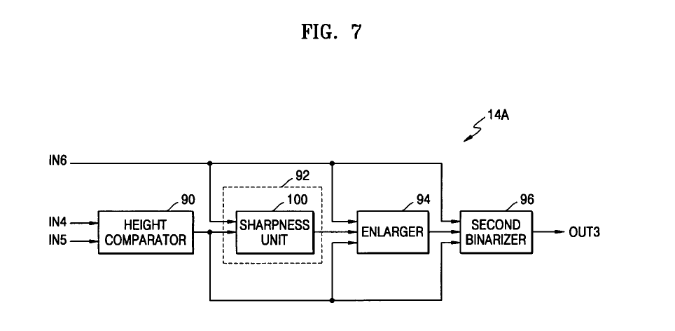

FIG. 7 is a block diagram of a character(s) extractor 14A according to an embodiment of the present invention. The character(s) extractor 14A includes a height comparator 90, a second sharpness adjuster 92, an enlarger 94, and a second binarizer 96.

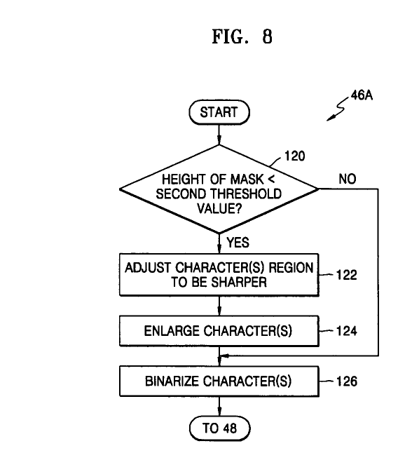

FIG. 8 is a flowchart illustrating operation 46A, according to an embodiment of the present invention. Operation 46A includes operations of sharpness and enlarging character(s) according to a height of a mask (operations 120 through 124) and binarizing the character(s) (operation 126).

The height comparator 90 compares the height of the mask received from the mask detector 10 via an input terminal IN4 with a second threshold value TH₂ received via an input terminal IN5 and outputs as a control signal a result of the comparison to both the second sharpness adjuster 92 and the second binarizer 96. The second threshold value TH₂ may be stored in the height comparator 90 in advance or can be received externally. For example, the height comparator 90 can determine whether the height of the mask is less than the second threshold value TH₂ and output the result of the determination as the control signal (Operation 120).

In response to the control signal generated by the height comparator 90, the second sharpness adjuster 92 adjusts the character(s) region to be sharper and outputs the character(s) region with adjusted sharpness to the enlarger 94. For example, when the second sharpness adjuster 92 determines that the height of the mask is less than the second threshold value TH₂ in response to the control signal received from the height comparator 90, the second sharpness adjuster 92 increases the sharpness of the character(s) region (operation 122). To this end, the second sharpness adjuster 92 receives a character(s) line from the mask detector 10 or the caption region detector 8 via an input terminal IN6 and a character(s) region and a background region within a scope indicated by the character(s) line from the first sharpness adjuster 12.

After operation 122, the enlarger 94 enlarges the character(s) included in the character(s) region, with their sharpness adjusted by the second sharpness adjuster 92, and outputs the result of the enlargement to the second binarizer 96 (operation 124).

According to an embodiment of the present invention, unlike the method illustrated in FIG. 8, operation 46A need not include operation 122. In this case, the character(s) extractor 14A of FIG. 7 does not include the second sharpness adjuster 92. Therefore, in response to the control signal received from the height comparator 90, when the enlarger 94 determines that the height of the mask is less than the second threshold value TH₂, it enlarges the character(s) in the character(s) region. To this end, the enlarger 94 may receive the character(s) line from the mask detector 10 via the input terminal IN6 and the character(s) region and the background region within the scope indicated by the character(s) line from the first sharpness adjuster 12 or the caption region detector 8 via the input terminal IN6.

In response to the control signal received from the height comparator 90, the second binarizer 96 binarizes character(s) enlarged or non-enlarged by the enlarger 94 using a third threshold value TH₃, determined for each character(s) line, and outputs the result of the binarization as extracted character(s) via an output terminal OUT 3. To this end, the second binarizer 96 receives the character(s) line from the mask detector 10 via the input terminal IN6 and the character(s) region and the background region within the area indicated by the character(s) line from the first sharpness adjuster 12 or the caption region detector 8 via the input terminal IN6.

For example, in response to the control signal, when the second binarizer 96 determines that the height of the mask is not less than the second threshold value TH₂, it binarizes the non-enlarged character(s) included in the scope indicated by the character(s) line (operation 126). However, when the second binarizer 96 determines that the height of the mask is less than the second threshold value TH₂ in response to the control signal, it binarizes the enlarged character(s) received from the enlarger 94 (operation 126).

Until now, only the character(s) region has been mentioned in describing the operation of the character(s) extractor 14A of FIG. 7. However, the background region as well as the character(s) region, within the scope indicated by the character(s) line, is processed by the second sharpness adjuster 92, the enlarger 94, and the second binarizer 96. In other words, the background region within the scope indicated by the character(s) line is enlarged by the enlarger 94 and binarized by the second binarizer 96.

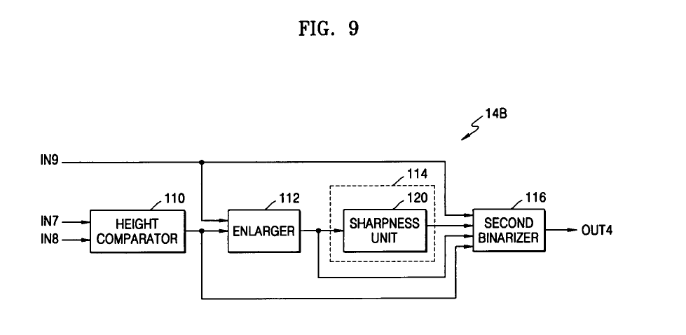

FIG. 9 is a block diagram of character(s) extractor 14B according to another embodiment of the present invention. The character(s) extractor 14B includes a height comparator 110, an enlarger 112, a second sharpness adjuster 114, and a second binarizer 116.

Unlike FIG. 8, when the height of the mask is less than the second threshold value TH₂, operation 124 may be performed instead of operation 122, operation 122 may be performed after operation 124, and operation 126 may be performed after operation 122. In this case, the character(s) extractor 14B illustrated in FIG. 9 may be implemented as the character(s) extractor 14 illustrated in FIG. 1.

The height comparator 110 illustrated in FIG. 9 performs the same functions as the height comparator 90 illustrated in FIG. 7. In other words, the height comparator 110 compares a height of a mask received from the mask detector 10 via an input terminal IN7 with the second threshold value TH₂ received via an input terminal IN8 and outputs as a control signal a result of the comparison to both the enlarger 112 and the second binarizer 116.

In response to the control signal received from the height comparator 110, when the enlarger 112 determines that the height of the mask is less than the second threshold value TH₂, it enlarges the character(s) included in a character(s) region. To this end, the enlarger 112 may receive a character(s) line from the mask detector 10, via an input terminal IN9, and the character(s) region and a background region within a scope indicated by the character(s) line from the first sharpness adjuster 12 or the caption region detector 8 via the input terminal IN9.

The second sharpness adjuster 114 adjusts the character(s) region including character(s) enlarged by the enlarger 112 to be sharper and outputs the character(s) region with adjusted sharpness to the second binarizer 116.

In response to the control signal received from the height comparator 110, the second binarizer 116 binarizes non-enlarged character(s) included in the character(s) region or character(s) included in the character(s) region with its sharpness adjusted by the second sharpness adjuster 114 using the third threshold value TH₃, and outputs the result of the binarization as extracted character(s) via an output terminal OUT 4. To this end, the second binarizer 116 receives the character(s) line from the mask detector 10 via the input terminal IN9 and the character(s) region and the background region within the scope indicated by the character(s) line from the first sharpness adjuster 12 or the caption region detector 8 via the input terminal IN9.

For example, in response to the control signal, when the second binarizer 116 determines that the height of the mask is not less than the second threshold value TH₂, it binarizes the non-enlarged character(s) included in the scope indicated by the character(s) line. However, when the second binarizer 116 determines that the height of the mask is less than the second threshold value TH₂ in response to the control signal, it binarizes the character(s) included in the character(s) region and having its sharpness adjusted by the second sharpness adjuster 114.

Until now, only the character(s) region has been mentioned in describing the operation of the character(s) extractor 14B of FIG. 9. However, the background region as well as the character(s) region, within the scope indicated by the character(s) line, is processed by the enlarger 112, the second sharpness adjuster 114, and the second binarizer 116. In otherwords, the background region, within the scope indicated by the character(s) line, is enlarged by the enlarger 112, processed by the second sharpness adjuster 114 to adjust the character(s) region to be sharper, and binarized by the second binarizer 116.

According to an embodiment of the present invention, unlike FIG. 9, the character(s) extractor 14B need not include the second sharpness adjuster 114. In this case, if the second binarizer 116 determines that the height of the mask is less than the second threshold value TH₂ in response to the control signal, it binarizes the character(s) enlarged by the enlarger 112.

According to an embodiment of the present invention, the enlarger 94 or 112 of FIG. 7 or 9 may determine the brightness of enlarged character(s) using a bi-cubic interpolation method. The bi-cubic interpolation method is discussed in “A Simplified Approach to Image Processing,” Prentice Hall, pp. 115-120, 1997, by Randy Crane.

A method of determining the brightness of enlarged character(s) using the bi-cubic interpolation method, according to an embodiment of the present invention, will now be described with reference to the attached drawings. However, the present invention is not limited thereto.

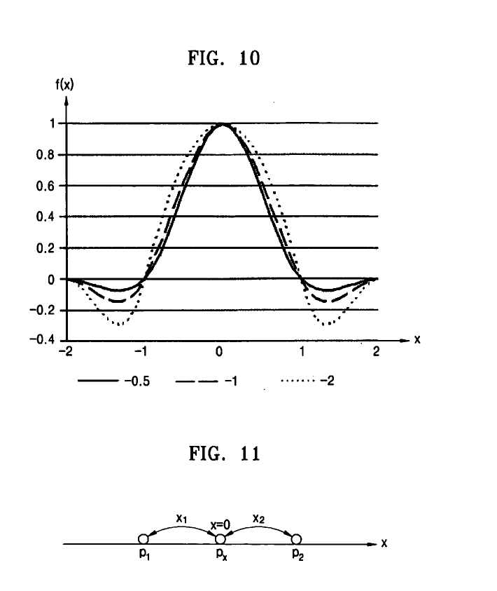

FIG. 10 is an exemplary graph illustrating a cubic function [f(x)] when a cubic coefficient is −0.5, −1, and −2, according to an embodiment of the present invention. Here, the horizontal axis indicates a distance from a pixel to be interpolated, and the vertical axis indicates the value of the cubic function.

FIG. 11 is a one-dimensional graph illustrating an interpolation pixel pₓ and neighboring pixels p₁ and p₂. Here, the interpolated pixel pₓ is newly generated as character(s) is/are enlarged and is a pixel to be interpolated, i.e., a pixel whose brightness should be determined. The neighboring pixel p₁ or p₂ denotes a pixel neighboring the interpolation pixel pₓ.

The cubic function illustrated in FIG. 10 is used as a weight function and may be given by, for example,

$$f ( x ) = \{ \begin{matrix}( a + 2 ) {\vert x \vert}^{3} - ( a + 3 ) {\vert x \vert}^{2} + 1 & 0 \leq \vert x \vert < 1 \\ ( a {\vert x \vert}^{3} - 5 a {\vert x \vert}^{2} + 8 a \vert x \vert - 4 a & 1 \leq \vert x \vert < 2 \\ 0 & 2 \leq \vert x \vert\end{matrix} \} , \qquad ( 2 )$$

where a is an integer.

For example, the weight is determined by substituting a distance x1 between the interpolation pixel pₓ and the neighboring pixel p₁ into Equation 2 instead of x or a weight corresponding to the distance x1 is determined from FIG. 10. Then, the determined weight is multiplied by the brightness, i.e., luminance level, of the neighboring pixel p₁. In addition, a weight is determined by substituting a distance x2 between the interpolation pixel pₓ and the neighboring pixel p₂ into Equation 2 instead of x or a weight corresponding to the distance x2 is determined by FIG. 10. Then, the determined weight is multiplied by the brightness, i.e., luminance level, of the neighboring pixel p₂. The results of the multiplication are summed, and the result of the summation is determined to be the luminance level, i.e., brightness, of the interpolation pixel pₓ.

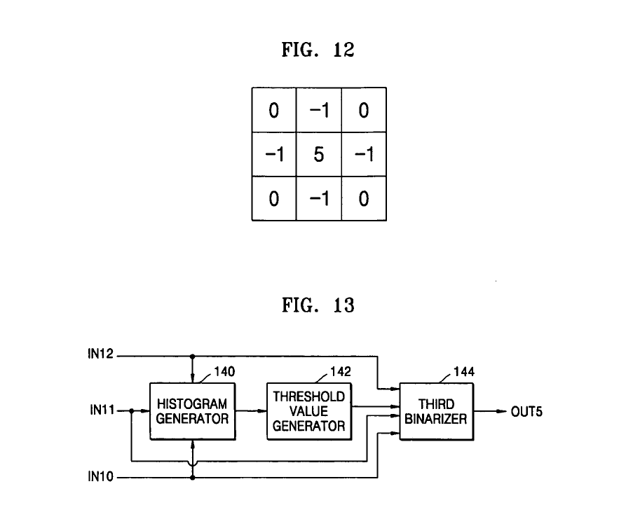

FIG. 12 illustrates a sharpness unit 100 or 120, according to an embodiment of the present invention. The second sharpness adjuster 92 or 112, illustrated in FIG. 7 or 9, play the role of adjusting the small character(s) to be sharper. To this end, the sharpness unit 100 or 120, which emphasizes an edge of an image, may be implemented as the second sharpness adjuster 92 or 114. The edge is a high frequency component of an image.

The sharpness unit 100 or 120 sharpens a character(s) region and a background region in a scope indicated by a character(s) line and outputs the sharpening result. The sharpening on image on the basis of high pass filter is discussed in “A Simplified Approach to Image Processing,” Prentice Hall, pp. 77-78, 1997, by Randy Crane. For example, the sharpness unit 100 or 120 may be implemented as illustrated in FIG. 12.

According to an embodiment of the present invention, the second binarizer 96 or 116, of FIG. 7 or 9, may binarize character(s) using Otsu's method. Otsu's method is discussed in a paper entitled “A Threshold Selection Method from Gray-scale Histograms,” IEEE Trans. Syst Man Cybern., SMC-9(1), pp. 62-66, 1986, by Jun Otsu.

FIG. 13 is a block diagram of the second binarizer 96 or 116, of FIG. 7 or 9, according to an embodiment of the present invention. The second binarizer 96 or 116 includes a histogram generator 140, a threshold value setter 142, and a third binarizer 144.

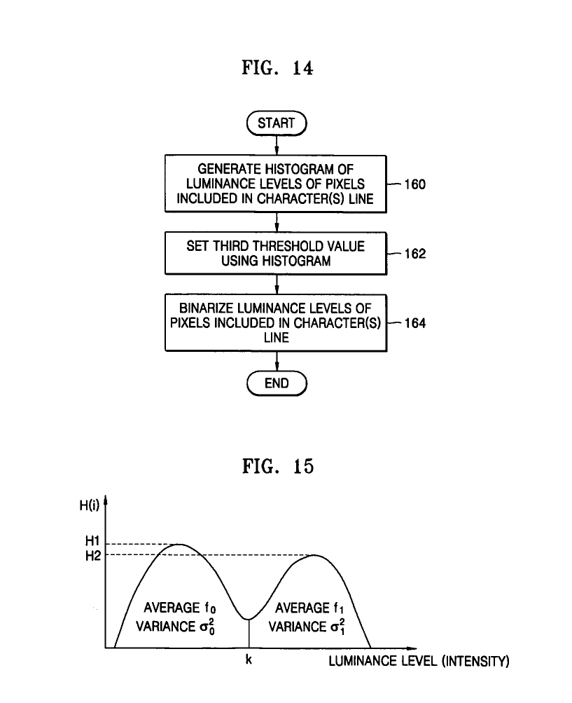

FIG. 14 is a flowchart illustrating a method of operating the second binarizer 96 or 116, according to an embodiment of the present invention. The method includes operations of setting a third threshold value TH₃ using a histogram (operations 160 and 162) and binarizing the luminance level of each pixel (operation 164).

FIG. 15 is an exemplary histogram according to an embodiment of the present invention, where the horizontal axis indicates luminance level and the vertical axis indicates a histogram [H(i)].

The histogram generator 140 illustrated in FIG. 13 generates a histogram of luminance levels of pixels included in a character(s) line and outputs the histogram to the threshold value setter 142 (operation 160). For example, in response to the control signal received via an input terminal IN10, if the histogram generator 140 determines that a height of a mask is not less than the second threshold value TH₂, it generates a histogram of luminance levels of pixels included in a character(s) region having non-enlarged character(s) and in a background region included in the scope indicated by the character(s) line. To this end, the histogram generator 140 may receive a character(s) line from the mask detector 10 via an input terminal IN11 and a character(s) region and a background region within a scope indicated by the character(s) line from the first sharpness adjuster 12 or the caption region detector 8 via the input terminal IN11.

However, in response to the control signal received via the input terminal IN10, if the histogram generator 140 determines that the height of the mask is less than the second threshold value TH₂, it generates a histogram of luminance levels of pixels included in a character(s) region having enlarged character(s) and in a background region belonging to the scope indicated by the character(s) line. To this end, the histogram generator 140 receives a character(s) line from the mask detector 10 via an input terminal IN12 and a character(s) region and a background region within the scope indicated by the character(s) line from the enlarger 94 or the second sharpness adjuster 114 via the input terminal IN12.

For example, the histogram generator 140 may generate a histogram as illustrated in FIG. 15.

After operation 160, the threshold value setter 142 sets a brightness value, which bisects a histogram which has two peak values received from the histogram generator 140 such that variances of the bisected histogram are maximized, as the third threshold value TH₃ and outputs the set third threshold value TH₃ to the third binarizer 144 (operation 162). Referring to FIG. 15, for example, the threshold value setter 142 can set a brightness value k, which bisects the histogram which has two peak values H1 and H2 such that variances σ₀² and σ₁² of the bisected histogram are maximized, as the third threshold value TH₃.

In a histogram distribution with two peak values H1 and H2, as illustrated in FIG. 15, a method of obtaining a brightness value k, i.e., the third threshold value TH₃, using the aforementioned Otsu's method, according to an embodiment of the presently claimed invention, will now be described.

Referring to FIG. 15, assuming that a range of luminance levels is 1 through m and a histogram value of a luminance level i is H(i), the number N of pixels that contributes to the generation of a histogram by the histogram generator 140 and a probability Pᵢ of each luminance level are obtained using Equations 3 and 4.

$$\begin{matrix}N = {\sum }_{i = 1}^{m} H ( i ) & ( 3 ) \\ {P}_{i} = \frac{H ( i )}{N} & ( 4 )\end{matrix}$$

When the histogram distribution of FIG. 15 is divided by the brightness value k into two regions C₀ and C₁, the probability e₀ that a luminance level of a pixel occurs in the region C₀ is expressed by Equation 5 and the probability e₁ that a luminance level of a pixel occurs in the region C₁ is expressed by Equation 6. In addition, an average f₀ of the region C₀ is calculated using Equation 7, and an average f₁ of the region C₁ is calculated using Equation 8.

$$\begin{matrix}{e}_{0} = {\sum }_{i = 1}^{k} {P}_{i} = e ( k ) & ( 5 ) \\ {e}_{1} = {\sum }_{i = k + 1}^{m} {P}_{i} = 1 - e ( k ) & ( 6 ) \\ {f}_{0} = {\sum }_{i = 1}^{k} ip ( i \vert {C}_{0} ) = {\sum }_{i = 1}^{k} \frac{{iP}_{i}}{{e}_{0}} = \frac{f ( k )}{e ( k )} & ( 7 ) \\ {f}_{1} = {\sum }_{i = k + 1}^{m} ip ( i \vert {C}_{1} ) = {\sum }_{i = k + 1}^{m} \frac{{iP}_{i}}{{e}_{1}} = \frac{f - f ( k )}{1 - e ( k )} & ( 8 )\end{matrix}$$

where the range of the region C₀ is from luminance level 1 to luminance level k and the range of the region C₁ is from luminance level (k+1) to luminance level m, f that is, f(k) are defined by Equation 9 and Equation 10, respectively.

$$\begin{matrix}f = {\sum }_{i = 1}^{m} ip & ( 9 ) \\ f ( k ) = {\sum }_{i = 1}^{k} {ip}_{i} & ( 10 )\end{matrix}$$

Therefore, f is given by
f=e_{O}f_{O}+e₁f₁ (11)

A sum [σ²(k)] of variances [σ₀²(k) and σ₁²(k)] of the two regions C₀ and C₁ is given by:

$$\begin{matrix}{σ}^{2} ( k ) = {σ}_{0}^{2} ( k ) + {σ}_{1}^{2} ( k ) \\ = {{e}_{0} ( {f}_{0} - f )}^{2} + {{e}_{1} ( {f}_{1} - f )}^{2} \\ = {e}_{0} {{e}_{1} ( {f}_{1} - {f}_{0} )}^{2} \\ = \frac{{[ fe ( k ) - f ( k ) ]}^{2}}{e ( k ) [ 1 - e ( k ) ]}\end{matrix} \qquad ( 12 )$$

Using Equation 12, the brightness value k for obtaining max σ²(k) is calculated.

After operation 162, the third binarizer 144 receives a character(s) line input with a scope including non-enlarged character(s) via an input terminal IN11 or a character(s) line with enlarged character(s) input via an input terminal IN12. The third binarizer 144 selects one of the received character(s) lines in response to the control signal input via the input terminal IN10. Then, the third binarizer 144 binarizes the luminance level of each of the pixels included in the character(s) region and the background region included in the scope indicated by the selected character(s) line using the third threshold value TH₃ and outputs the result of the binarization via an output terminal OUT5 (operation 164).

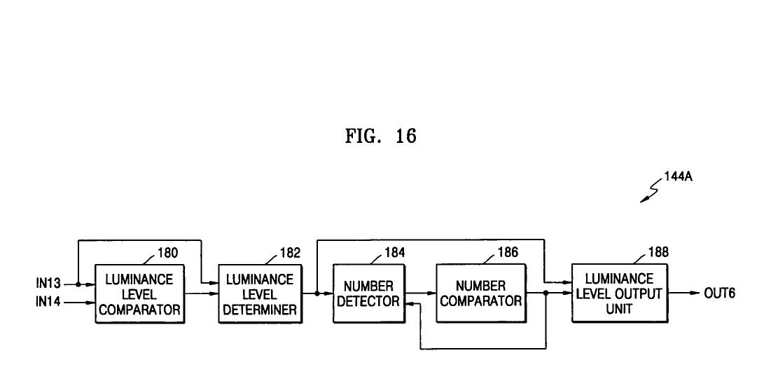

FIG. 16 is a block diagram of a third binarizer 144A, according to an embodiment of the present invention. The third binarizer 144A includes a luminance level comparator 180, a luminance level determiner 182, a number detector 184, a number comparator 186, and a luminance level output unit 188.

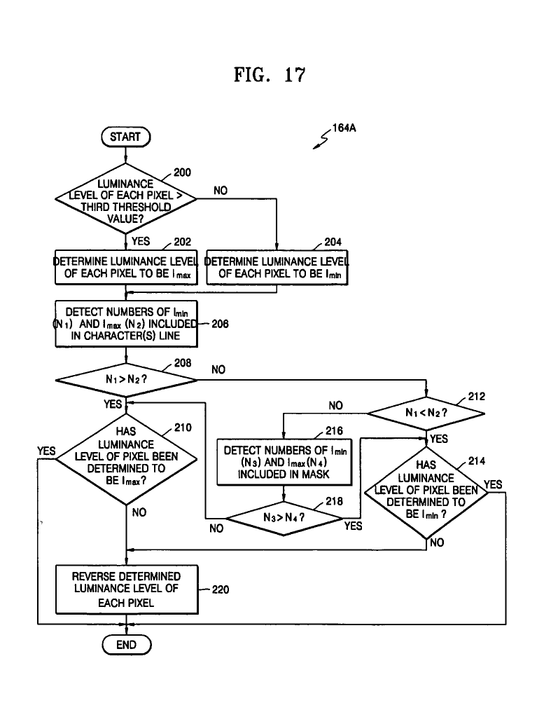

FIG. 17 is a flowchart illustrating operation 164A, according to an embodiment of the present invention. Operation 164A includes operations of determining the luminance level of each pixel (operations 200 through 204), verifying whether the luminance level of each pixel has been determined properly (operations 206 through 218), and reversing the determined luminance level of each pixel according to the result of the verification (operation 220).

The luminance level comparator 180 compares the luminance level of each of the pixels included in a character(s) line with the third threshold value TH₃ received from the threshold setter 142 via an input terminal IN14 and outputs the results of the comparison to the luminance level determiner 182 (operation 200). To this end, the luminance level comparator 180 receives a character(s) line, and a character(s) region and a background region in a scope indicated by the character(s) line via an input terminal IN13. For example, the luminance level comparator 180 determines whether the luminance level of each of the pixels included in the character(s) line is greater than the third threshold value TH₃.

In response to the result of the comparison by the luminance level comparator 180, the luminance level determiner 182 determines the luminance level of each of the pixels to be a maximum luminance level (Imax) or a minimum luminance level (Imin) and outputs the result of the determination to both the number detector 184 and the luminance level output unit 188 (operations 202 and 204). The maximum luminance level (Imax) and the minimum luminance level (Imin) may denote, for example, a maximum value and a minimum value of luminance level of the histogram of FIG. 15, respectively.

For example, if the luminance level determiner 182 determines that the luminance level of pixel is greater than the third threshold value TH₃ based on the result of the comparison by the luminance level comparator 180, it determines the luminance level of the pixel input via an input terminal IN13 to be the maximum luminance level (Imax) (operation 202). However, if the luminance level determiner 182 determines that the luminance level of the pixel is equal to or less than the third threshold value TH₃ based on the result of the comparison by the luminance level comparator 180, it determines the luminance level of the pixel input via the input terminal IN13 to be the minimum luminance level (Imin) (operation 204).

The number detector 184 detects the number of maximum luminance levels (Imaxes) and the number of minimum luminance levels (Imins) included in a character(s) line or a mask and outputs the detected number of maximum luminance levels (Imaxes) and the detected number of minimum luminance levels (Imins) to the number comparator 186 (operations 206 and 216).

The number comparator 186 compares the number of minimum luminance levels (Imins) with the number of maximum luminance levels (Imaxes) and outputs the result of the comparison (operations 208, 212, and 218).

In response to the result of the comparison by the number comparator 186, the luminance level output unit 188 bypasses the luminance levels of the pixels determined by the luminance level determiner 182 via an output terminal OUT6 or reverses and outputs the received luminance levels of the pixels via the output terminal OUT6 (operations 210, 214, and 220).

For example, after operation 202 or 204, the number detector 184 detects a first number N₁, which is the number of maximum luminance levels (Imaxes) included in a character(s) line, and a second number N₂, which is the number of minimum luminance levels (Imins) included in the character(s) line, and outputs the detected first and second numbers N₁ and N₂ to the number comparator 186 (operation 206).

After operation 206, the number comparator 186 determines whether the first number N₁ is greater than the second number N₂ (operation 208). If it is determined through the comparison result of the number comparator 186 that the first number N₁ is equal to the second number N₂, the number detector 184 detects a third number N₃, which is the number of minimum luminance levels (Imins) included in a mask, and a fourth number N₄, which is the number of maximum luminance levels (Imaxes) included in the mask, and outputs the detected third and fourth numbers N₃ and N₄ to the number comparator 186 (operation 216).

After operation 216, the number comparator 186 determines whether the third number N₃ is greater than the fourth number N₄ (operation 218). If the luminance level output unit 188 determines through the comparison result of the number comparator 186 that the first number N₁ is greater than the second number N₂, or the third number N₃ is smaller than the fourth number N₄, it determines whether the luminance level of pixel included in the character(s) is determined to be the maximum luminance level Imax (operation 210).

If the luminance level output unit 188 determines that the luminance level of pixel included in the character(s) is not determined to be the maximum luminance level (Imax), it reverses the luminance level of the pixel determined by the luminance level determiner 182 and outputs the reversed luminance level of the pixel via the output terminal OUT6 (operation 220).

However, if the luminance level output unit 188 determines that the luminance level of the pixel included in the character(s) is determined to be the maximum luminance level (Imax), it bypasses the luminance level of the pixel determined by the luminance level determiner 182. The bypassed luminance level of the pixel is output via the output terminal OUT6.

If the luminance level output unit 188 determines through the comparison result of the number comparator 186 that the first number N₁ is smaller than the second number N₂, or the third number N₃ is greater than the fourth number N₄, it determines whether the luminance level of each of the pixels included in the character(s) is determined to be the minimum luminance level (Imin) (operation 214).

If the luminance level output unit 188 determines that the luminance level of pixel included in the character(s) is not determined to be the minimum luminance level (Imin), it reverses the luminance level of the pixel determined by the luminance level determiner 182. The reversed luminance level of the pixel is output via the output terminal OUT6 (operation 220).

However, if the luminance level output unit 188 determines that the luminance level of the pixel included in the character(s) is determined to be the minimum luminance level (Imin), it bypasses the luminance level of each of the pixels determined by the luminance level determiner 182 and outputs the bypassed luminance level of the pixel via the output terminal OUT6.

According to another embodiment of the present invention, unlike in the method illustrated in FIG. 17, operation 164 may not include operations 212, 216, and 218. In this case, if the first number N₁ is not greater than the second number N₂, it is determined whether the luminance level of the pixel is determined to be the minimum luminance level (Imin) (operation 214). This embodiment may be useful when the first number N₁ is not the same as the second number N₂.

According to another embodiment of the present invention, unlike in the method illustrated in FIG. 17, in Operation 164, when the luminance level of each of the pixels is greater than the third threshold value TH₃, the luminance level of the pixel may be determined to be the minimum luminance level (Imin), and, when the luminance level of each of the pixels is not greater than the third threshold value TH₃, the luminance level of the pixel may be determined to be the maximum luminance level (Imax).

After operation 46 of FIG. 2, the noise remover 16 removes noise from the character(s) extracted by the character(s) extractor 14 and outputs the character(s) without noise via the output terminal OUT1 (operation 48 of FIG. 2).

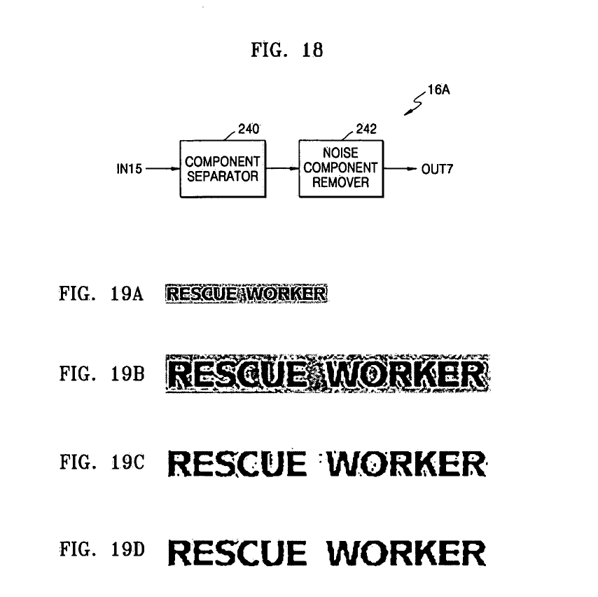

FIG. 18 is a block diagram of a noise remover 16A, according to an embodiment of the present invention. The noise remover 16A includes a component separator 240 and a noise component remover 242.

The component separator 240 spatially separates extracted character(s) received from the character(s) extractor 14 via an input terminal IN15 and outputs the spatially separated character(s) to the noise component remover 242. Here, any text has components, that is, characters. For example, the text “rescue” can be separated into the individual characters “r,” “e,” “s,” “c,” “u,” and “e.” However, each character may also have a noise component.

According to an embodiment of the present invention, the component separator 240 can separate components using a connected component labelling method. The connected component labelling method is discussed in a book entitled “Machine Vision,” McGraw-Hill, pp. 44-47, 1995, by R. Jain, R. Kastuni, and B. G. Schunck.

The noise component remover 242 removes noise components from the separated components and outputs the result via an output terminal OUT7. To this end, the noise component remover 242 may remove, as noise components, a component including less than a predetermined number of pixels, a component having a region larger than a predetermined region which is a part of the entire region of a character(s) line, or a component having width wider than a predetermined width which is a part of the overall width of the character(s) line. For example, the predetermined number may be 10, the predetermined region may take up 50% of the entire region of the character(s) line, and the predetermined width may take up 90% of the overall width of the character(s) line.

The character(s) whose noise has been removed by the noise remover 16 may be output to, for example, OCR (not shown). The OCR receives and recognizes the character(s) without noise and identifies the contents of an image containing the character(s) using the recognized character(s). Then, through the identification result, the OCR can summarize an image (images), search an image including only the contents desired by a user, or index an image by contents. In other words, the OCR can index, summarize, or search a moving image for a home server/a next-generation PC, which is the video contents management based on contents of the moving image.

Therefore, for example, news can be summarized or searched, an image can be searched, or important sports information can be extracted by using character(s) extracted by an apparatus and method for extracting character(s) from an image, according to an embodiment of the present invention.

The apparatus for extracting character(s) from an image, according to an embodiment of the present invention, need not include the noise remover 16. In other words, the method of extracting character(s) from an image illustrated in FIG. 2 need not include operation 48. In this case, character(s) extracted by the character(s) extractor 14 is directly output to the OCR.

For a better understanding of the present invention, it is assumed that character(s) in a character(s) region is “rescue worker” and that the character(s) extractor 14A of FIG. 7 is implemented as the character(s) extractor 14 of FIG. 1. Based on these assumptions, the operation of the apparatus for extracting character(s) from an image, according to an embodiment of the present invention, will now be further described with reference to the attached drawings.

FIGS. 19A through 19D illustrate an input and an output of the character(s) extractor 14A and the noise remover 16 of FIG. 7.

The sharpness unit 92 of FIG. 7 adjusts the character(s) region “rescue worker” to be sharper and outputs the character(s) region with adjusted sharpness, as illustrated in FIG. 19A to the enlarger 94. The enlarger 94 receives and enlarges the character(s) region and the background region illustrated in FIG. 19A and outputs the enlarged result illustrated in FIG. 19B to the second binarizer 96. The second binarizer 96 receives and binarizes the enlarged result illustrated in FIG. 19B and outputs the binarized result illustrated in FIG. 19C to the noise remover 16. The noise remover 16 removes noise from the binarized result illustrated in FIG. 19C and outputs the character(s) region without noise as illustrated in FIG. 19D via the output terminal OUT1.

As described above, an apparatus, medium, and method for extracting character(s) from an image, according to embodiments of the present invention, can recognize even small character(s) with, for example, a height of 12 pixels and with significant and important information of an image. In particular, since character(s) are binarized using a third threshold value TH₃ for each character(s) line, the contents of an image can be identified by recognizing extracted character(s). Hence, an image can be more accurately summarized, searched, or indexed according to its contents. Further, faster character(s) extraction is possible since time and spatial information of an image, which is created when detecting a conventional caption region, are used without a caption region detector 8.

Embodiments of the present invention may be implemented through computer readable code/instructions on a medium, e.g., a computer-readable medium, including but not limited to storage media such as magnetic storage media (ROMs, RAMs, floppy disks, magnetic tapes, etc.), optically readable media (CD-ROMs, DVDs, etc.), and carrier waves (e.g., transmission over the internet). Embodiments of the present invention may also be embodied as a medium(s) having a computer-readable code embodied therein for causing a number of computer systems connected via a network to effect distributed processing. The functional programs, codes and code segments for embodying the present invention may be easily deducted by programmers in the art which the present invention belongs to.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus for extracting character(s) from an image, comprising:
a mask detector detecting a height of a mask indicating a character(s) region from spatial information of the image created when detecting a caption region of the image; and
a character(s) extractor extracting character(s) from the character(s) region corresponding to a height of the mask.

2. The apparatus of claim 1, wherein the apparatus further comprises a first sharpness adjuster adjusting the character(s) region to be sharper, and the character(s) extractor extracts the character(s) from the character(s) region with adjusted sharpness.

3. The apparatus of claim 2, wherein the first sharpness adjuster comprises a time average calculator calculating a time average of luminance levels of caption regions having the same character(s), and the character(s) extractor extracts the character(s) from the character(s) region having a luminance level equal to the calculated average.

4. The apparatus of claim 1, further comprising a noise remover removing noise from extracted character(s).

5. The apparatus of claim 4, wherein the noise remover comprises:
a component separator spatially separating components of the extracted character(s); and
a noise component remover removing a noise component from separated components and outputting character(s) without the noise component.

6. The apparatus of claim 5, wherein the component separator separates the components using a connected component labeling method.

7. The apparatus of claim 5, wherein the noise component remover removes, as a noise component, a component having less than a predetermined number of pixels, a component having a region larger than a predetermined region which is a part of an entire region of a character(s) line, or a component wider than a predetermined width which is a part of an overall width of the character(s) line, and the character(s) line indicates a width corresponding to the height of the mask as a scope comprising the at least character(s) region in the caption region.

8. The apparatus of claim 1, wherein the mask detector comprises:
a first binarizer binarizing the spatial information using a first threshold value;
a mask generator generating the mask by removing holes within the character(s) from the binarized spatial information; and
a line detector outputting the height of the mask and indicating a width corresponding to the height of the mask as a scope comprising at least the character(s) region in the caption region.

9. The apparatus of claim 8, wherein the mask generator comprises a morphology filter morphology-filtering the binarized spatial information and outputting a result of the morphology-filtering as the mask.

10. The apparatus of claim 9, wherein the morphology filter generates the mask by performing a dilation method on the binarized spatial information.

11. The apparatus of claim 8, wherein the character(s) extractor comprises:
a height comparator comparing the height of the mask to a second threshold value and outputting a control signal as the result of the comparison;
an enlarger enlarging the character(s) included in the character(s) region in response to the control signal; and
a second binarizer binarizing the enlarged or non-enlarged character(s) using a third threshold value determined for every character(s) line and outputting a result of the binarization as the extracted character(s) in response to the control signal.

12. The apparatus of claim 11, wherein the character(s) extractor further comprises a second sharpness adjuster adjusting the character(s) region to be sharper in response to the control signal, and the enlarger enlarges the character(s) included in the character(s) region with the sharpness adjusted by the second sharpness adjuster.

13. The apparatus of claim 11, wherein the character(s) extractor further comprises the second sharpness adjuster adjusting the character(s) region having the enlarged character(s) to be sharper, and the second binarizer binarizes the non-enlarged character(s) or the character(s) included in the character(s) region with the sharpness adjusted by the second sharpness adjuster by using the third threshold value determined for every character(s) line and outputting the result of the binarization as the extracted character(s) in response to the control signal.

14. The apparatus of claim 11, wherein the enlarger determines the brightness of the enlarged character(s) using a bi-cubic interpolation method.

15. The apparatus of claim 12, wherein the second sharpness adjuster comprises a sharpness unit sharpening the character(s) region and the background region in the scope indicated by the character(s) line and outputting the result of the sharpening.

16. The apparatus of claim 11, wherein the second binarizer binarizes the character(s) using Otsu's method.

17. The apparatus of claim 11, wherein the second binarizer comprises:
a histogram generator generating a histogram of luminance levels of pixels included in the character(s) region and the background region in the scope indicated by the character(s) line;
a threshold value setter setting a brightness value, bisecting the histogram which has two peak values such that variances of the bisected histogram are maximized, as the third threshold value; and
a third binarizer selecting a character(s) line having the enlarged character(s) or a character(s) line having the non-enlarged character(s) in response to the control signal, binarizing the luminance level of each of the pixels in the scope indicated by a selected character(s) line by using the third threshold value, and outputting a result of the third binarization.

18. The apparatus of claim 17, wherein the third binarizer comprises:
a luminance level comparator comparing a luminance level of each of the pixels with the third threshold value;
a luminance level determiner setting the luminance level of each of the pixels as a maximum luminance level or a minimum luminance level in response to a result of the luminance level comparison;
a number detector detecting a number of maximum luminance levels and a number of minimum luminance levels included in the character(s) line;
a number comparator comparing the number of minimum luminance levels and the number of maximum luminance levels; and
a luminance level output unit bypassing the luminance level of each pixel determined by the luminance level determiner or reversing and outputting the luminance level of each pixel determined by the luminance level determiner in response to a result of the comparison by the number comparator.

19. The apparatus of claim 18, wherein the number detector detects the number of maximum luminance levels and the number of minimum luminance levels included in the mask in response to the result of the comparison by the number comparator.

20. A method of extracting character(s) from an image, comprising:
obtaining a height of a mask indicating a character(s) region from spatial information of the image created when detecting a caption region comprising the character(s) region and a background region from the image; and
extracting the character(s) from the character(s) region corresponding to the height of the mask,
wherein the spatial information comprises an edge gradient of the image.

21. The method of claim 20, wherein the method further comprises adjusting the character(s) region to be sharper, and the character(s) is extracted from the character(s) region with adjusted sharpness.

22. The method of claim 20, further comprising removing noise from the extracted character(s).

23. The method of claim 20, wherein the extracting of the character(s) comprises:
determining whether the height of the mask is less than a second threshold value;
enlarging the character(s) included in the character(s) region when it is determined that the height of the mask is less than the second threshold value; and
binarizing the non-enlarged character(s) when it is determined that the height of the mask is not less than the second threshold value, binarizing the enlarged character(s) when it is determined that the height of the mask is less than the second threshold value, and determining a result of the binarization as the extracted character(s).

24. The method of claim 23, wherein the extracting of the character(s) further comprises adjusting the character(s) region to be sharper when it is determined that the height of the mask is less than the second threshold value, and the enlarging of the character(s) comprises enlarging each character included in the character(s) region with the adjusted sharpness.

25. The method of claim 23, wherein the extracting the character(s) further comprises adjusting the character(s) region having the enlarged character(s) after enlarging the character(s) to be sharper, the non-enlarged character(s) is binarized when it is determined that the height of the mask is not less than the second threshold value, character(s) included in the character(s) region with the adjusted sharpness is binarized when it is determined that the height of the mask is less than the second threshold value, and a result of the non-enlarged character(a) and/or adjusted sharpness binarization is determined as the extracted character(s).

26. The method of claim 24, wherein the determining of the result of the binarization as the extracted character(s) comprises:
generating a histogram of luminance levels of pixels included in the background region and the character(s) region having the non-enlarged character(s) in a scope indicated by the character(s) line when it is determined that the height of the mask is not less than the second threshold value and generating a histogram of luminance levels of pixels included in the background region and the character(s) region having the enlarged character(s) in the scope indicated by the character(s) line when it is determined that the height of the mask is less than the second threshold value;
setting a brightness value, bisecting the histogram which has two peak values such that variances of the bisected histogram are maximized, as the third threshold value; and
binarizing the luminance level of each of the pixels included in the scope indicated by the character(s) line using the third threshold value,
and the character(s) line indicates a width corresponding to the height of the mask as the scope including at least the character(s) region in the caption region.

27. The method of claim 26, wherein the binarizing of the luminance level of each of the pixels comprises:
determining whether the luminance level of each of the pixels is greater than the third threshold value;
determining respectively the luminance levels of the pixels to be maximum luminance levels when it is determined that the luminance levels of the pixels are greater than the third threshold value and determining, respectively, the luminance levels of the pixels to be minimum luminance levels when it is determined that the luminance levels of the pixels are equal to or less than the third threshold value;
detecting a first number, which is a number of minimum luminance levels included in the character(s) line, and a second number, which is the number of maximum luminance levels included in the character(s) line;
determining whether the first number is greater than the second number;
determining whether the luminance levels of the pixels included in the character(s) are determined to be the maximum luminance levels respectively when it is determined that the first number is greater than the second number;
determining whether the luminance levels of the pixels included in the character(s) are determined to be the minimum luminance levels respectively when it is determined that the first number is less than the second number; and
reversing the luminance levels of the pixels included in the character(s) line when it is determined that the luminance levels of the pixels included in the character(s) are not determined to be the maximum luminance levels or the minimum luminance levels.

28. The method of claim 26, wherein the binarizing of the luminance level of each of the pixels comprises:
determining whether the luminance level of each of the pixels is greater than the third threshold value;
determining, respectively, the luminance levels of the pixels to be the minimum luminance levels when it is determined that the luminance levels of the pixels are greater than the third threshold value and determining, respectively, the luminance levels of the pixels to be the maximum luminance levels when it is determined that the luminance levels of the pixels are equal to or less than the third threshold value;
detecting a first number, which is the number of minimum luminance levels included in the character(s) line, and a second number, which is the number of maximum luminance levels included in the character(s) line;
determining whether the first number is greater than the second number;
determining whether the luminance levels of the pixels included in the character(s) are determined to be the maximum luminance levels respectively when it is determined that the first number is greater than the second number;
determining whether the luminance levels of the pixels included in the character(s) are determined to be the minimum luminance level respectively when it is determined that the first number is less than the second number; and
reversing the luminance levels of the pixels included in the character(s) line when it is determined that the luminance levels of the pixels included in the character(s) are not determined to be the maximum luminance levels or the minimum luminance levels.

29. The method of claim 27, wherein the binarizing of the luminance level of each of the pixel further comprises:
detecting a third number, which is a number of minimum luminance levels included in the mask, and a fourth number, which is a number of maximum luminance levels included in the mask, when it is determined that the first number is equal to the second number;
determining whether the third number is greater than the fourth number;
determining whether the luminance levels of the pixels included in the character(s) are determined to be the minimum luminance levels respectively when it is determined that the third number is greater than the fourth number; and
determining whether the luminance levels of the pixels included in the character(s) are determined to be the maximum luminance levels respectively when it is determined that the third number is less than the fourth number.

30. The apparatus of claim 1, wherein the caption region comprises the character(s) region and a background region.

31. The apparatus of claim 1, wherein the spatial information comprises an edge gradient of the image.

32. A method of extracting character(s) from an image, comprising:
obtaining a character(s) region from a caption region;
enlarging character(s) in the character(s) region; and
extracting the character(s) from the character region.

33. The method of claim 32, further comprising:
obtaining a height of a mask indicating the character region.

34. The method of claim 32, further comprising:
obtaining the character(s) region using the spatial information.

35. The method of claim 32, wherein the spatial information comprises an edge gradient of the image.

36. The method of claim 32, wherein the caption region comprises a background region.

37. The method of claim 32, further comprising:
removing a noise from the extracted character(s).

38. A method of extracting character(s) from an image, comprising:
obtaining a height of a mask indicating a character(s) region from a spatial information of the image created when detecting a caption region from the image; and
extracting character(s) from the character(s) region corresponding to the height of the mask,
wherein the extracting of the character(s) comprises:
determining whether the height of the mask is less than a second threshold value;
enlarging the character(s) included in the character(s) region when it is determined that the height of the mask is less than the second threshold value; and
binarizing non-enlarged character(s) when it is determined that the height of the mask is not less than the second threshold value, binarizing the enlarged character(s) when it is determined that the height of the mask is less than the second threshold value, and determining a result of the binarization as the extracted character(s).

39. The method of claim 38, further comprises:
binarizing the spatial information detector by using a first threshold value.

40. The method of claim 38, further comprises:
increasing a sharpness of the character(s) region in accordance with a control signal.

41. The method of claim 40, wherein the control signal is the determination of the height of the mask being less than the second threshold value.

42. A medium comprising computer readable code implementing the method of claim 20.

43. A medium comprising computer readable code implementing the method of claim 32.

44. A medium comprising computer readable code implementing the method of claim 38.
